(19) United States
(12) Patent Application Publication
(10) Pub. No.: US 2012/0295232 A1
(43) Pub. Date: Nov. 22, 2012

(54) Touch sense device for the visually impaired

(76) Inventor: Stephen Sophorn Lim, Desert Hot Springs, CA (US)

(21) Appl. No.: 13/135,979

(22) Filed: Jul. 20, 2011

Related U.S. Application Data
(60) Provisional application No. 61/462,475, filed on Feb. 3, 2011.

(51) Int. Cl. G09B 21/02

(52) U.S. Cl. 434/115

(57) ABSTRACT

A touch sense device (TSD) implements an electrical pulse technology to mimic a Braille dot includes a series of sensor cells. A sensor cell consists of eight dots is composed of an anode (+) and cathode (−) electrodes with each dot arranged in a two by four matrices portraying a Braille syntax. Depending on the Braille characters, low electrical currents are passed through different positioned anodes, when touched by a finger delivers currents to the cathode completing the electrical circuits forming character dot(s); there provides a communication device for reading, writing, editing, and/or social media interactions for the visually impaired individuals.

### CROSS-REFERENCE TO RELATED APPLICATION

Not Applicable

### FEDERALLY SPONSORED RESEARCH

Not Applicable

### SEQUENCE LISTING OR PROGRAM

Not Applicable

### BACKGROUND OF THE INVENTION

### Field of Invention

The provisional patent application No. 61/462,475 initiated on Feb. 3, 2011 relates to improving and replacing the solenoids and mechanical actuating components in the Braille Touch Sense Display (TSD) for the visually impaired. The replacement of the mechanical actuating components resulted to many benefits especially smaller in size and lighter in weight, which makes it portable and convenient for everyday user. The innovation introduced an electric pulse technology, which mimic the Braille dot via electrical pulse in the TSD providing reading, writing, editing, and social media interaction easily for the visually impaired. The known technology is implemented in an electronic massager with low frequency current delivering to the human body via electrode pads.

### DESCRIPTION OF PRIOR INVENTION

The Braille system was developed by Louis Braille in 1824, a visually impaired French teacher who derived a communication method of dot punching technique to represent alphabets and characters for mean of communication between the visually impaired and other individuals. Based on the Braille system, the protrusion of either one to six or eight dots depending on character notated in two rows of six or eight matrices.

The invention of the touch sense device (TSD) is to improve, develop, and replace mechanical actuating components on an existing displaying devices for the visually impaired, like the Refreshable Scanning Tactile Graphic Display For Localized Sensory Stimulation from: US 2003/0117371 A1 (RST-LSS), U.S. Pat. No. 6,700,553 B2 (Becker et al.) and other similar touch-reading devices. Several known mechanical actuating components are the solenoids, piezoelectric, gears, drive belts and drive motors. Many Braille reading device implement actuators, typically solenoids to make a cell of dot matrices, which surmount to space usage. An example of an eight solenoids cell to make a word, containing 5 alphabet characters, the display will require 5 cells and at least 40 solenoids within each the cell. Some Braille reading devices implement gears, drive belts and drive motors to minimize the use of solenoid actuators.

A solenoid is an electromechanical device that protrudes in and out of a coil element when electric current is applied. Solenoids also have many great advantages for it uses i.e. automatic lock for automobiles, home doors, and commercial businesses to name a few. For the Braille devices, solenoids are one of the chosen components for making the Braille protrusion dots resemblance. For the Braille reading devices that uses the solenoids and/or mechanical actuating parts, here are some disadvantages:
(a) Size: The structural mechanical parts, coil and magnets can only be made small enough, but takes a bit of solenoids to make one Braille character. There, an eight solenoids cell to make a word, containing 5 alphabet characters, the display will require 5 cells and 40 solenoids within the cell.
(b) Weight: A single solenoid may not be much in weight to implement in a display monitor but the Braille reading display requires more than one solenoid aside from other components actuators, gears, drive belts and electric motor for making the Braille dot. With such components utilized in the device is a lot of weight to carry and cumbersome for everyday use.
(c) Components Problems: A portable reading device implement many solenoids, actuators, gears, drive belts and motors are prone to frequent maintenance and wear and tear due to solenoids and mechanical actuating parts.
(d) Energy Usage: The reading device may use more energy due to multiple solenoids and mechanical actuating parts usage.
   In addition, the essential multiple solenoid components and mechanical actuating parts may be expensive to manufacture.

### OBJECTS AND ADVANTAGES

Dissecting in depth from provisional patent application No. 61/462,475. The technology for eliminating the solenoids and mechanical components for the touch sense display derives a few objects and advantages:
(a) To provide a smaller in weight product when replaced with an electrical pulse for reading, writing, editing, and social media related activities and for portability and convenience for everyday use.
(b) To provide a lighter in weight product when replaced with an electrical pulse for reading, writing, editing, and social media read activities and convenience for everyday use.
(c) To provide a minor to no components problems with an electrical pulse, there providing less to no maintenance due to little to none mechanical actuating parts.
(d) To provide an energy efficient product; for the TSD uses less metal content with an innovative approach to use a low frequency current controlled to mimic a Braille dot for touch sensed to the finger in lieu of solenoids and mechanical actuating parts.
   The advantage of the electronic pulse is that the majority of the components are 4 pieces, each bonded together to make a cell, arranged side by side to make a Touch Sense Display, connected to a computing unit and input/output peripherals making a Braille reading, writing, editing, and social media display.

### SUMMARY

In accordance with my present invention, the approach is to improve, develop, and replace an existing Braille reading device the solenoid actuators, piezoelectric, gears, and any mechanical actuating components with an electrical pulse technology. The technology concentrates on the cell of the Braille touch sense display (TSD).

### DRAWINGS

### Figures

In the drawings, figures contain the same reference numbers in some views. There contain different views and assembly views of the components essential for the TSD.

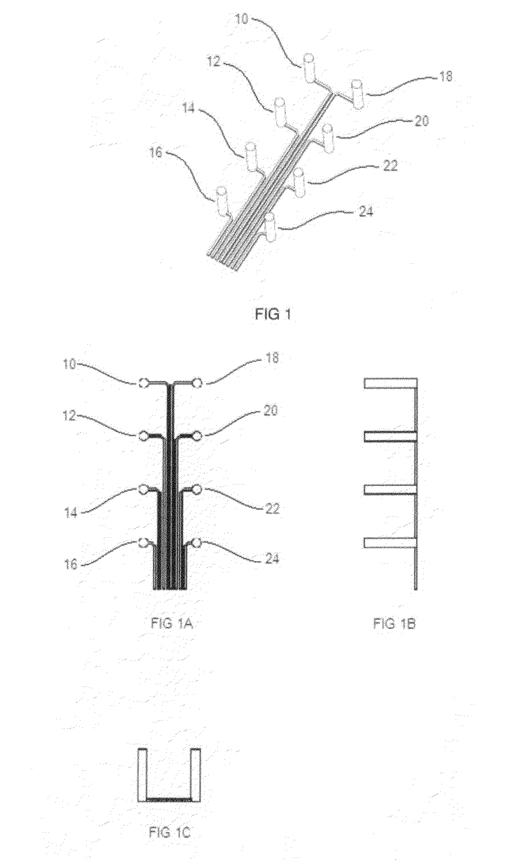

FIGS. 1 to 1C show general and various side views of the electrode bonded to the shaped wiring with assigned position for each electrode for the cell.

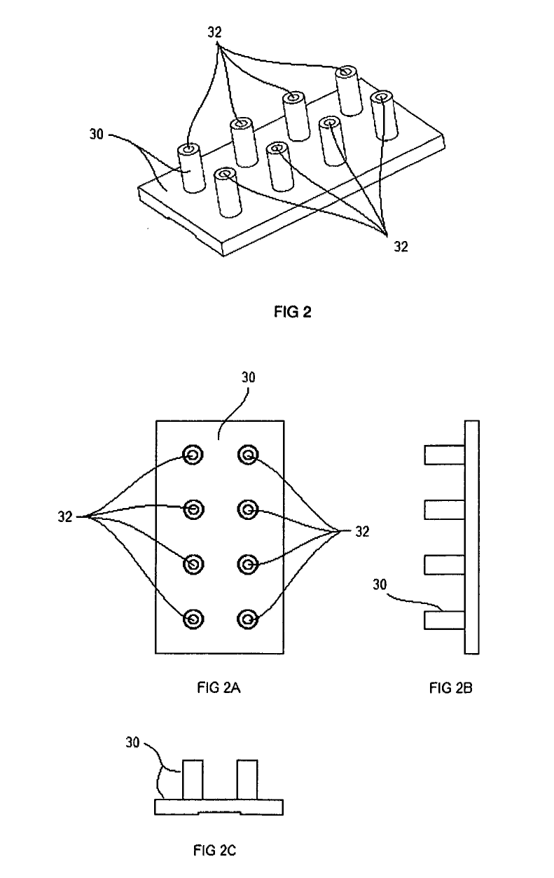

FIGS. 2 to 2C show general and various side views of the insulator between the anode (+) and cathode (−) plate with the insert hole for the electrodes.

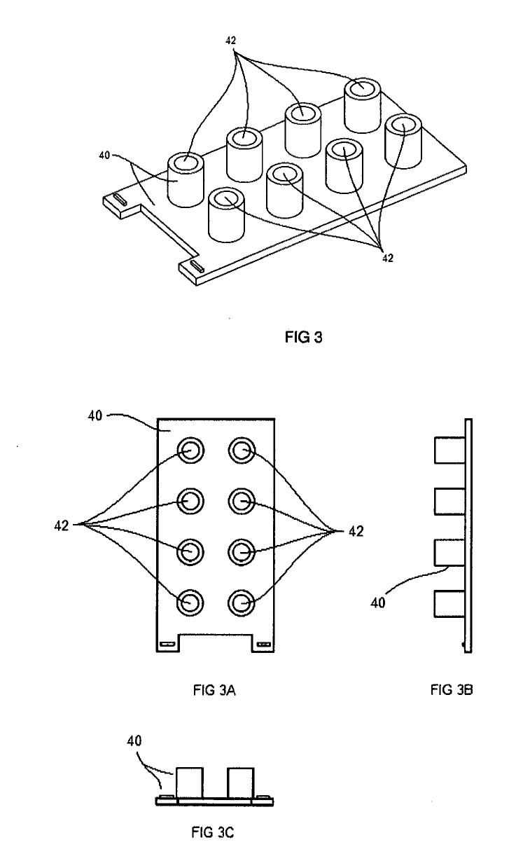

FIGS. 3 to 3C show general and various side views of the cathode plate with insert holes for the insulator between the anode (+) and cathode (−) plate.

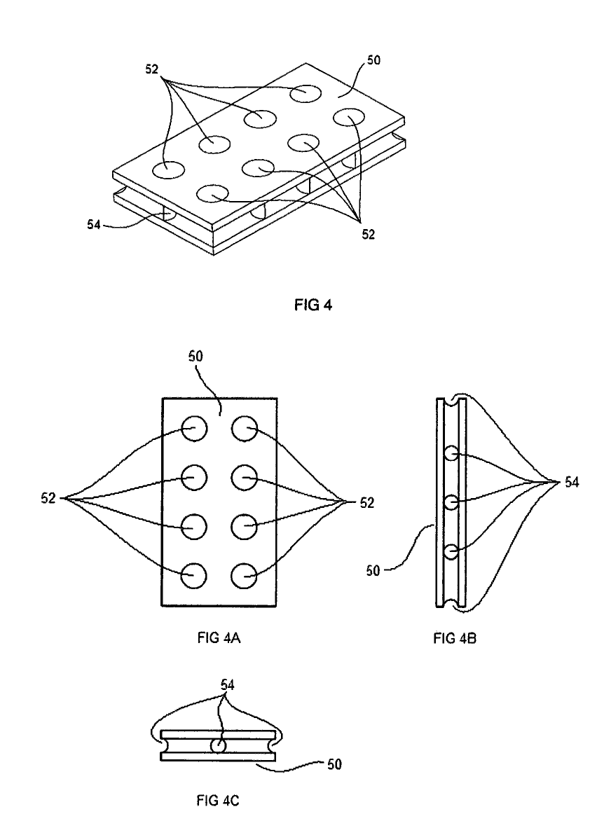

FIGS. 4 to 4C show general and various side views of the surface insulator plate with insert holes for the cathode plate.

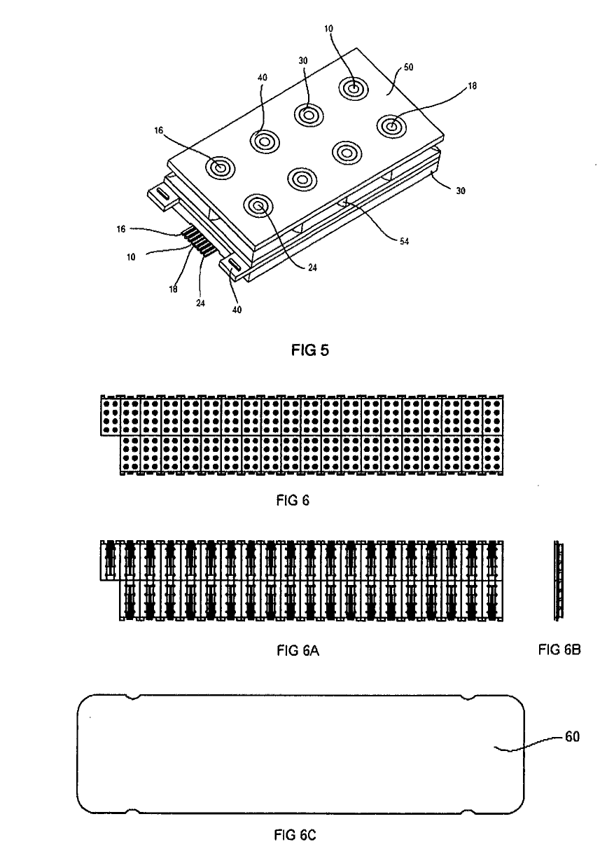

FIG. 5 shows complete cell assembly with the surface insulator, cathode plate, anode and cathode insulator, and electrodes, in an orderly stack with the preformed wires.

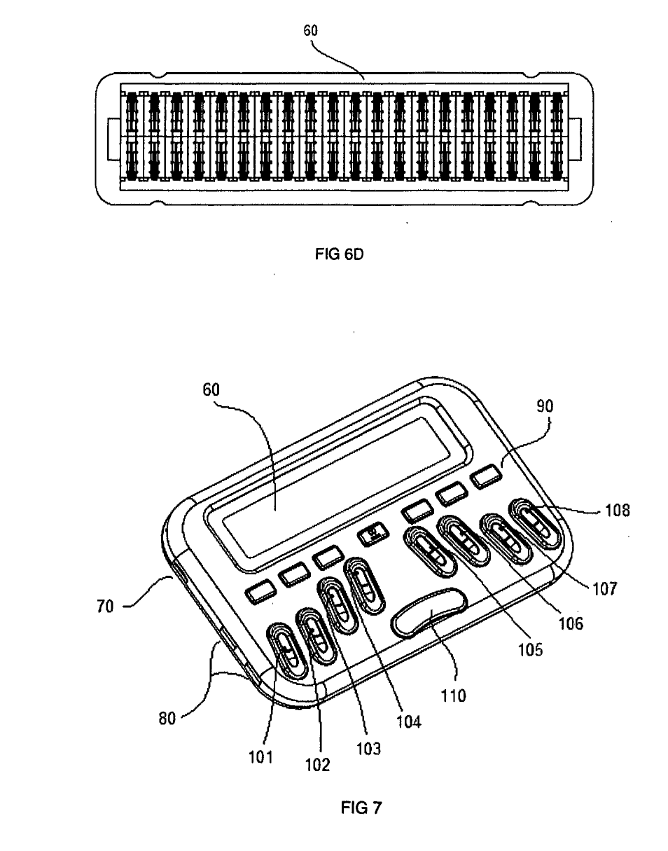

FIGS. 6 to 6D show various front and side views of the cells arranged side by side onto the pulse transfer cover plate to make up the touch sense display, (TSD).

FIG. 7 shows the Braille reading device product with the TSD assembled into the products with the finger buttons, feature keys, and ports for various applications.

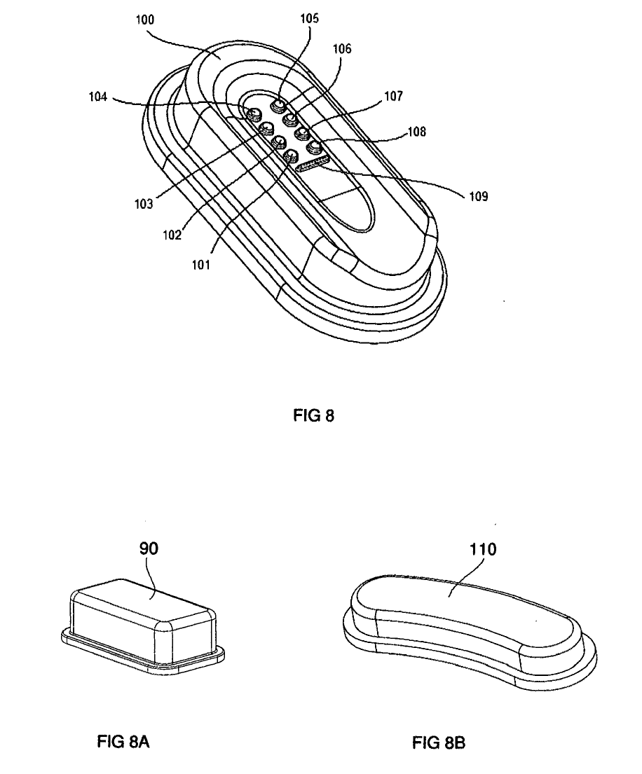

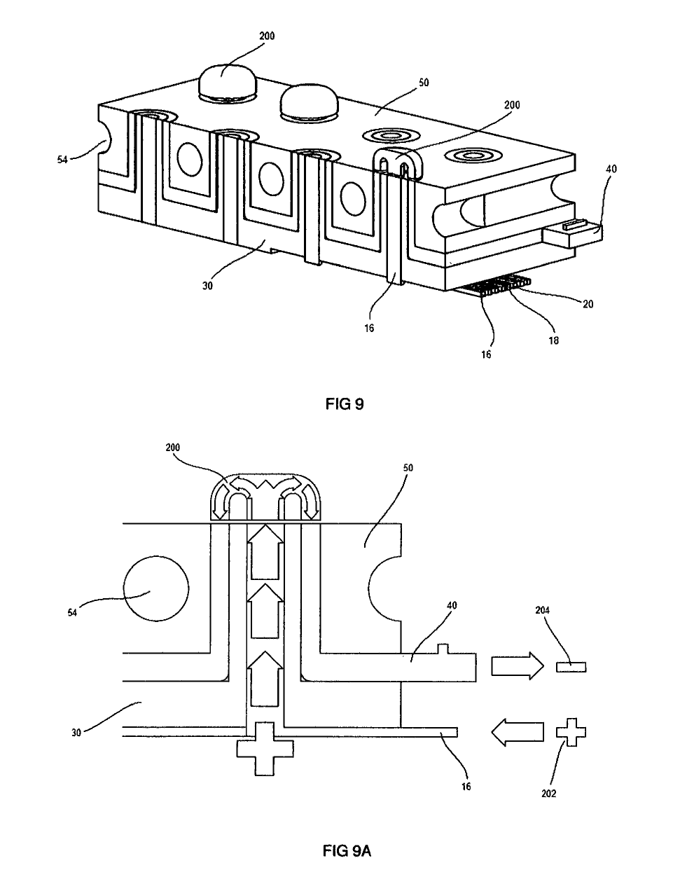

FIGS. 8 to 8B show the key buttons with dot identification position within the button to provide the end user with finger location.

FIGS. 9 to 9A show the cut portion of the assembled cell with the Braille dot effect when electric current is applied to position electrode (not showing the finger which completes the electric circuit) passing through to the cathode plate.

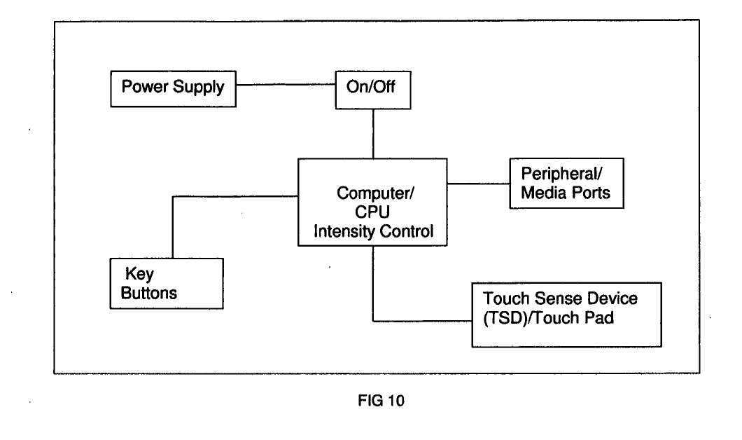

FIG. 10 shows the computer structure layout of the Braille reading device with the Computer/CPU and Intensity Control at the center surrounded by the Power Supply, On/Off Switch, Key Buttons, Peripheral/Media Ports, and Touch Sense Display.

### REFERENCE NUMERALS

| | | | |
|---|---|---|---|
| 10 | Position Electrode (A1) | 12 | Position Electrode (A2) |
| 14 | Position Electrode (A3) | 16 | Position Electrode (A4) |
| 18 | Position Electrode (B1) | 20 | Position Electrode (B2) |
| 22 | Position Electrode (B3) | 24 | Position Electrode (B4) |
| 30 | An/Cat Insulator Plate (+/−) | 32 | Electrode Insert Hole |
| 40 | Cathode Plate (−) | 42 | An/Cat Insulator Insert Hole |
| 50 | Surface Insulator | 52 | Cathode Plate Hole |
| 54 | Air Circulation Port | 60 | Pulse Transfer Cover Plate |
| 70 | Power Port | 80 | USB Ports |
| 90 | Feature Buttons | 100 | Key Button |
| 101 | Key Button (A4) | 102 | Key Button (A3) |
| 103 | Key Button (A2) | 104 | Key Button (A1) |
| 105 | Key Button (B1) | 106 | Key Button (B2) |
| 107 | Key Button (B3) | 108 | Key Button (B4) |
| 109 | Reference Mark | 110 | Space Bar Button |

### DETAILED DESCRIPTION

### FIGS. 1-1C

### Embodiment

A preferred embodiment contains a series of electrodes placed in a configuration bonded by wires directed to one port connection; each electrode assigned to represent a coordinated position in 10, 12, 14, 16, 18, 20, 22, 24, forming a two by four matrix cell. Each electrode assigned as an anode (+) will have a diameter around 0.5 mm with length that is no thicker than the entire cell. The electrodes shall be composed of a metal material that conducts electricity.

### FIGS. 2-2C

### Embodiment

A preferred embodiment contains an anode and cathode insulation plate (30) with an electrode insert hole (32). The outer most diameter of the electrode insert hole shall be around 1.0 mm. The material may be of a lightweight ceramic or any well composed insulator.

### FIGS. 3-3C

### Embodiment

A preferred embodiment contains a cathode plate (40) with an anode/cathode insert hole (42). The outer most diameter of the anode/cathode insert hole shall be around 1.5 mm. The cathode plate may be composed of a lightweight metal material that conducts electricity.

### FIGS. 4-4C

### Embodiment

A preferred embodiment contains a surface insulator (50) with a cathode plate hole (52). The fitting hole is to be around 1.5 mm. The insulator is equipped with an air circulation port (54) when assembled completes an air circulating passage for the displaying unit. The selected material may be of a lightweight ceramic or any well composed insulator.

### FIGS. 5, 6-6D

### Embodiment

A preferred embodiment of the cell in a complete assembly there contain with the upper surface (50) main insulator as an enclosure of the cathode plate hole (52) fitting for the cathode plate (40), within the cathode plate there contain an An/Cat Insulator Insert Hole (42) fitting for the anode and cathode insulator plate (30), within the anode and cathode insulator plate there contain an electrode insert hole (32) fitting for the position electrodes (10, 12, 14, 16, 18, 20, 22, 24).

A preferred embodiment of the cells arranged side by side in FIGS. 6-6B aligning the air circulation port (54). The upper surface (50) of the cell set side by side are bonded to the pulse transfer cover plate (60) completing the assembly of the electronic pulse display or touch sense device (TSD) in FIG. 6D.

### FIGS. 7, 8-8B

### Embodiment

A preferred embodiment of the electronic pulse display is placed into the frame of the unit with the feature button (90), key button (100), and space button (110).

A preferred embodiment for the key button are arranged in the format of key button (101) with a dot position and reference mark (109) assigned to position electrode (16); key button (102) with a dot position and reference mark (109) assigned to position electrode (14); key button (103) with a dot position and reference mark (109) assigned to position electrode (12); key button (104) with a dot position and reference mark (109) assigned to position electrode (10); key button (105) with a dot position and reference mark (109) assigned to position electrode (24); key button (106) with a dot position and reference mark (109) assigned to position electrode (22); key button (107) with a dot position and reference mark (109) assigned to position electrode (20); key button (108) with a dot position and reference mark (109) assigned to (18).

### Operations—FIGS. 9-9A, 10

At the preferred embodiment of the cell, when a given signal (204) frequency is passed through position electrode (16, 18, 20) with finger touches the cell, a complete signal is delivered through the cathode plate (30) there forming a pulse like sensation (200) by the finger portraying a Braille dot. The frequency may have a range from 1 Hz to 100 Hz; there the intensity may be control through the feature button (90).

FIG. 10 shows the computer structure layout of the Braille reading device with the Computer/CPU and Intensity Control being the center of operation with the linkage to the Power Supply, On/Off Switch, Key Buttons, Peripheral/Media Ports, and Touch Sense Display. The power supply connects to the on/off switch to the CPU provides the energy for operation is used with rechargeable batteries of either alkaline or lithium based elements. The key buttons are linked directly to the CPU, which function is for Braille text to be displayed in the TSD when created by the user. Each key button contains a dot on the surface of the button for user identification and also assigned position to link to each cell electrode position within the cell of the TSD. The touch sense display is linked to the intensity control on through the CPU and it function is to provide reading, writing, and editing created by the user. The intensity control provides the visually impaired with the level of sensation (current passing through) when finger touches the TSD. The peripheral and media ports are input and output ports for connecting charger cable, USB cables and adapters, microphones, headphones, and other essential media devices.

An approach for the computer structure layout in FIG. 10 may be implemented but if there exist a better approach using a software link may be utilized. For assembled cells in FIG. 6D, the TSD there connects to computer/CPU and the intensity of electronic pulse contains a control feature. The intensity will provide the user with the level of sensation when their finger touches the TSD.

### Advantages

From the description above, a number of advantages of my TSD reading device for the visually impaired become evident that;
(a) Touch sense device contains no solenoids and mechanical actuating parts which functions the same as to deliver the Braille dot via by method of electric current;
(b) Without the use of the solenoids, actuator of gears and drive belts, the TSD will require little to no maintenance, hardly any wear and tear;
(c) A unique optional feature, the user will not need to move fingers around. The character or alphabets is optioned to scroll back and forth while the fingers stay put. The dots on the screen will not be shown and the electronic Braille dot pulses are transmitted when fingers are in contact;
(d) A unique prospect feature, the TSD can be developed to be compatible with many computers, where user can enjoy the World Wide Web or social media and experience full picture touch sense base by method of the one position hand touch and the electronic pulse to generate a whole picture beside the electronic Braille dot.

### CONCLUSION, RAMIFICATIONS, AND SCOPE

There are many approaches to developing a Braille reading devices for the visually impaired individual, but the nature of the Touch Sense Display invention was to introduce a new method of developing a reading device. The innovative approach is to implement an electronic pulse and eliminate all solenoids and any mechanical actuating parts and components, which expands from provisional patent application No. 61/462,475. The idea of an electronic impulse, like that of a low frequency electronic massager, and but the TSD will control the pulse surface area by method of anode and cathode current delivery there providing the Braille dot diameter.

The TSD effectiveness is in the lighter in weight and smaller in sizes, therefore it provides portability, convenience and many great prospects for the visually impaired individuals. One of the options is that the TSD may be developed so that the letters can scroll back and forth while the fingers stay put. The dots on the screen will not be shown and the electronic pulses can be sensed when fingers are in contact. And when the fingers are removed, no pulse is generated. When enough energy is applied from one electrode to the other, sensation via fingers sensations of the electrical pulse can be felt throughout.

The claims below detail the scope of the invention of the Touch Sense Display.

I claim:

1. The Touch Sense Display (TSD) innovative approach is to be developed by method of implementing an electronic pulse creating low frequency controlled current there generates an electronic Braille dot for reading, writing, editing and social media application, hence is said to contain no solenoids or mechanical actuating parts or components;

2. In accordance with claim 1 wherein said the TSD are

3. Lighter in weight with no solenoids and/or little moving parts with little to no metal material usage;

4. Smaller in size than other Braille reading devices due to mechanical components reduction and/or total elimination providing portability and convenience for everyday usage.

5. The cell assembled in FIG. 5 there contain the upper surface (50) main insulator as an enclosure of the cathode plate hole (52) fitting for the cathode plate (40), within the cathode plate there contain an An/Cat Insulator Insert Hole (42) fitting for the anode and cathode insulator plate (30), within the anode and cathode insulator plate there contain an electrode insert hole (32) fitting for the position electrodes (10, 12, 14, 16, 18, 20, 22, 24).

6. In accordance with claim 5 wherein said the cell assembled contains an air circulation port (54) for cooling of the unit.

7. In accordance with claim 5 wherein said the cells are arranged side by side in FIGS. 6-6B there contain alignment of the air circulation port (54) for cooling. The upper surface (50) of the cell set side by side are bonded to the pulse transfer cover plate (60) completing the assembly of the electronic pulse display or touch sense device (TSD) in FIG. 6D.

8. The Key Button, FIG. 8 contains a dot on the surface of the button for user identification and also assigned position to link to each cell electrode positioned within the cell of the TSD.

9. In accordance with claim 8 wherein said the key button is individually, to contain the Braille dot at specific locations for user's identification.

10. There claimed the TSD functions that when a given frequency signal (204) is passed through position electrode (16, 18, 20) with finger lightly touches the cell, a complete signal is delivered through the cathode plate (30) there forming a pulse like sensation (200) by the finger portraying a Braille dot.

11. There claimed a unique optional feature, the user will need not move fingers around. The character or alphabets is optioned to scroll back and forth while the fingers stay put. The dots on the screen will not be shown and the electronic Braille dot pulses are transmitted when fingers are in contact.

12. There claimed a unique prospect feature, the TSD can be developed to be compatible with many computers, the World Wide Web and/or social media interaction;

13. In accordance with claim 12, user may option in lieu of plain Braille dot language for a full image experience developed by the electronic pulse with method of hand placed on the Touch Screen Display.
